(19) United States
(12) Patent Application Publication
(10) Pub. No.: US 2002/0180769 A1
(43) Pub. Date: Dec. 5, 2002

(54) Screen auto-alignment system

(76) Inventors: Kent Yin, Hsinchu (TW); Chung-Yao Chen, Fen-Yuan Hsiang (TW); Thomas Lee, Da-She Hsiang (TW)

Correspondence Address: J.C. Patents, Inc., Suite 250, 4 Venture, Irvine, CA, 92618, US

(21) Appl. No.: 10/160,878

(22) Filed: May 31, 2002

(30) Foreign Application Priority Data
May 31, 2001 (TW) 90113160

(51) Int. Cl. G09G 5/02

(52) U.S. Cl. 345/699

(57) ABSTRACT

An auto-alignment system and a method for adjusting a picture image relative to a monitor screen. Video signals are detected by a video detection circuit detects and sent to a micro-controller. The micro-controller performs a computation of the received video signal, produces a set of data including a horizontal size, a horizontal phase, a vertical size and a vertical phase and sends the data to a deflection controller. The deflection controller adjusts position and size of the picture image relative to the monitor screen.

### CROSS-REFERENCE TO RELATED APPLICATION

This application claims the priority benefit of Taiwan application serial no. 90113160, filed May 31, 2001.

### BACKGROUND OF THE INVENTION

1. Field of Invention

The present invention relates to a system for adjusting phase and size of a picture image relative to a screen. More particularly, the present invention relates to a system capable of automatically adjusting phase and size of a picture image relative to a screen.

2. Description of Related Art

At the end of monitor production, the monitors must be tested before delivery to customers. In general, picture image is also adjusted at this time so that suitable size and position relative to the screen of the monitor is obtained. FIG. 1 is a schematic layout showing a system for pre-adjusting a picture image on the screen of a monitor inside a conventional monitor fabricating facility. When the system is switched on, a microcontroller 102 sends a video signal having a digital data format to a deflection controller 104 through a digital bus 112 (alternatively, an interface I/O bus). The deflection controller 104 receives the video signal and converts the video signal into a video signal raised to several thousand volts. The high-voltage video signal is sent to a monitor 106. Thus, a picture image appears on a picture screen of the monitor 106. An auto-alignment system 108 tracks the size and position of the picture image on the screen 114 and extracts relevant data. Such picture data is sent from the auto-alignment system 108 via the digital bus 112 to the microcontroller 102. According to the incoming data, the micro-controller 102 decides to move the picture image in a particular direction or to adjust the size of the picture image. As soon as the picture image is adjusted to a tolerable level, the micro-controller 102 sends the registered information including horizontal size, horizontal phase, vertical size and vertical phase to an electrically erasable programmable read only memory (EEPROM) 110. In addition, according to various commonly used frequency signals encountered by the monitor 106, information for setting the horizontal size, horizontal phase, vertical size and vertical phase at these frequency signals is transferred to the EEPROM 110.

FIG. 2 is a schematic diagram showing a conventional monitor system. Upon switching the system on, a micro-controller 202 in the system determines the type of frequency mode transmitted from a video graphic adapter (VGA) card 204. According to the frequency mode, the micro-controller 202 fetches data regarding horizontal size, horizontal phase, vertical size and vertical phase from an EEPROM 206. Such data is sent from the micro-controller 202 to a deflection controller 208. With such an arrangement, the deflection controller 208 is able to convert signals submitted by the VGA card 204 into a picture image having the correct size and position on a display screen 210.

However, there are as many as several hundred commonly used frequency modes. Hence, it is virtually impossible to include the horizontal size, horizontal phase, vertical size and vertical phase that correspond to a particular frequency mode for every one of the frequency modes. Once a monitor encounters a frequency mode having no pre-recorded data for the necessary adjustment, alignment of the picture image can only be achieved through estimation. For example, a fixed value is used or a frequency mode having pre-recorded data and closest to the desired frequency mode is selected. Under such circumstances, an optimal picture image adjustment is hard to secure.

### SUMMARY OF THE INVENTION

Accordingly, one object of the present invention is to provide an auto-alignment system for the screen of a monitor. Through the system, position and size of a picture image relative to the screen can be adjusted automatically without the need to accumulate corresponding data including horizontal size, horizontal phase, vertical size and vertical phase of various frequency modes.

To achieve these and other advantages and in accordance with the purpose of the invention, as embodied and broadly described herein, the invention provides an auto-alignment system for a monitor screen. The system serves to adjust position and size of a picture image relative to the monitor screen. The system includes a storage device, a micro-controller, a deflection controller and a video detection circuit. The storage device stores a first horizontal size value, a second horizontal size value, a first vertical size value, a second vertical size value, a vertical position value and a shift value. The micro-controller provides a horizontal video signal and a vertical video signal to adjust the size of the picture image and then records the horizontal size value and vertical size value corresponding to this position. The horizontal size value and the vertical size value are stored in the storage device. The micro-controller also adjusts a raster scan region and records the vertical position value and the shift value in the storage device. According to the horizontal video signal and the vertical video signal, the micro-controller computes a horizontal position value, a ratio, a horizontal scan line value, a shift vertical position value, a plug-in horizontal size value and a plug-in vertical size value by reading out the horizontal size value, the vertical size value and the shift value from the storage device. The computed horizontal position value, ratio, horizontal scan line value, shift vertical position value, plug-in horizontal size value and plug-in vertical size value are used as data for adjusting the picture image. The deflection controller is coupled to the micro-controller for receiving the horizontal video signal, the vertical video signal, the horizontal size value, the vertical size value, the horizontal scan line value, the vertical position value, the shift value, the horizontal position value, the ratio, the shift vertical position value, the plug-in horizontal size value and the plug-in vertical size value and outputting a deflection signal to the monitor for adjusting the picture image of the monitor. The deflection controller also issues a horizontal flyback electrical signal and a vertical flyback electrical signal. The video detection circuit is coupled to the microcontroller for receiving the horizontal flyback signal and the vertical flyback signal from the deflection controller and converting into a horizontal flyback digital signal and a vertical flyback digital signal. The horizontal flyback digital signal and the vertical flyback digital signal are sent to the micro-controller. The video detection circuit is also capable of receiving data from an image pre-amplifier and converting the same into digital data. The converted digital data is then transferred to the micro-controller.

This invention provides an auto-alignment method for adjusting picture image on the screen of a monitor. The method is principally used for adjusting position and size of picture image relative to a monitor screen before delivering the monitors to customers. First, a first effective video cycle ratio horizontal signal and a first effective video cycle ratio vertical signal are provided. According to the first effective video cycle ratio horizontal signal and the first effective video cycle ratio vertical signal, size of the picture image on the screen is adjusted to a suitable level. Thereafter, a first horizontal size value and a first vertical size value of the picture image are recorded. Similarly, a second effective video cycle ratio horizontal signal and a second effective video cycle ratio vertical signal are provided. According to the second effective video cycle ratio horizontal signal and the second effective video cycle ratio vertical signal, size of the picture image on the screen is adjusted to a suitable level. Thereafter, a second horizontal size value and a second vertical size value of the picture image are recorded. A signal having a zero vertical front porch and a zero vertical back porch is provided. A horizontal scan line value is next recorded. The horizontal scan line value is the sum of all the horizontal scan lines in the vertical front porch, the vertical back porch and the effective video cycle. The picture image is adjusted to suitable size and then raster scan height is measured. A vertical position value corresponding to the scan height is recorded. According to the range of the vertical range, the vertical position value is adjusted. Finally, a shift value related to the vertical position value and the horizontal scan line value is recorded.

This invention also provides an alternative method for adjusting the picture image on the screen of a monitor. The method is principally used for adjusting position and size of picture image relative to a monitor screen before delivering the monitors to customers. First, a plurality of data is read from an image amplifier. According to the data, horizontal phase, horizontal size, vertical phase and vertical size of the picture image are adjusted.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic layout showing a system for pre-adjusting picture image on the screen of a monitor inside a conventional monitor fabricating facility;

FIG. 2 is a schematic diagram showing a conventional monitor system;

FIG. 3 is a schematic layout showing an auto-alignment system for adjusting a picture image on the screen of a monitor according to this invention;

FIG. 4 is a diagram showing various video signals in operation;

FIG. 5 is a diagram showing programmable horizontal and vertical video signals generated by a micro-controller;

FIG. 6 is a flow chart showing the steps for aligning monitors before delivery to customers according to this invention;

FIG. 7 is a diagram showing a micro-controller providing a horizontal effective video cycle of 65% and 85% respectively;

FIG. 8 is a diagram showing a micro-controller providing a vertical effective video cycle of 65% and 85% respectively;

FIG. 9 is a diagram showing a micro-controller providing an auto-alignment signal having a vertical phase;

FIG. 10 is a flow chart showing the steps for performing a user-initiated monitor auto-alignment;

FIG. 11 is a flow chart showing the steps for performing a horizontal phase adjustment of a picture image;

FIG. 12 is a sketch showing various horizontal phase adjustments of a picture image;

FIG. 13 is a flow chart showing the steps for performing a horizontal size adjustment of a picture image;

FIG. 14 is a diagram showing the finding of a horizontal size value from a picture image through internal difference;

FIG. 15 is a flow chart showing the steps for performing a vertical phase adjustment of a picture image;

FIG. 16A is a sketch showing a raster scan region displaced from the center of a screen;

FIG. 16B is a sketch showing the process of moving a raster scan region leading to the positioning of a picture image in the middle of the screen;

FIG. 17 is a flow chart showing the steps for performing a vertical size adjustment of a picture image; and

FIG. 18 is a diagram showing the finding of a vertical size value from a picture image through internal difference.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

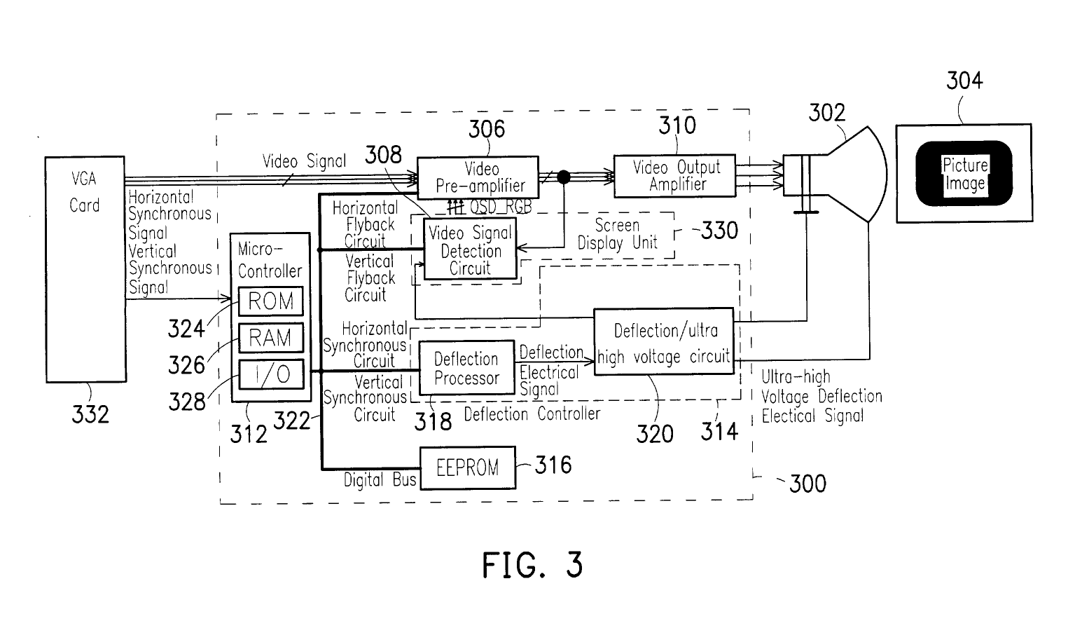

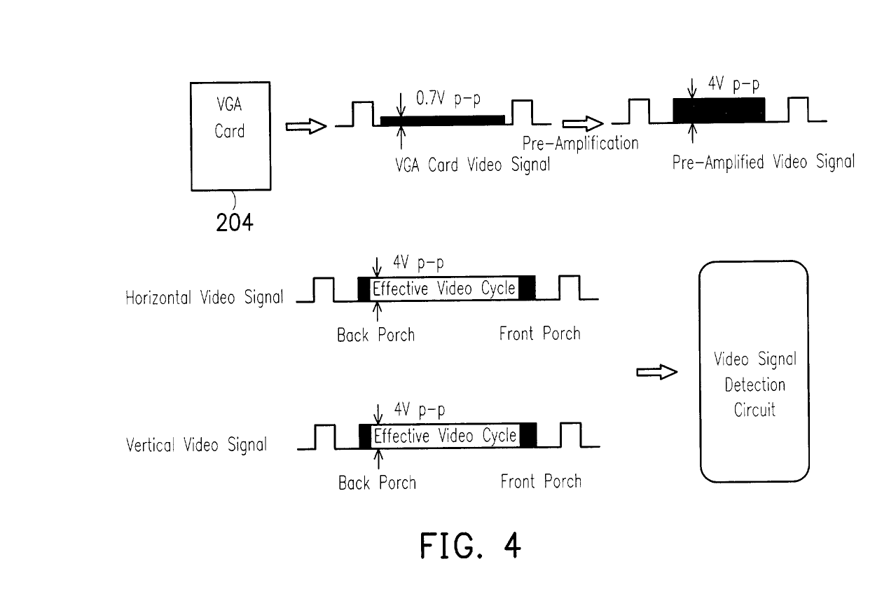

FIG. 3 is a schematic layout showing an auto-alignment system for adjusting a picture image on the screen of a monitor according to this invention. As shown in FIG. 3, a screen auto-alignment system 300 is provided. The system 300 is used mainly for adjusting position and size of a picture image relative to the screen 304 of a monitor 302. A pre-amplifier 306 in the screen auto-alignment system 300 performs a video signal pre-amplification as shown in FIG. 4. In general, the video signal emitted from a video graphic card (VGA) card 332 is 0.7Vp-p. The video signal is raised to about 4-4.5 Vp-p by the pre-amplifier 306 and then the amplified video signal is sent to a video detection circuit 308.

The video pre-amplifier is capable of receiving a video signal from the micro-controller 312 so that a picture image on the screen 304 can be automatically adjusted prior to shipment of the monitor 302 to a customer. In addition, the video pre-amplifier 306 is also capable of receiving video signals from a VGA card 332 (most VGA cards are plugged into an interior slot inside a computer rather than inside the monitor 302). Hence, a user can adjust the relative position of a picture image on the screen 304 internally and automatically.

A video output amplifier 310 is coupled to the video pre-amplifier 306. Since the picture image must be displayed on the screen 304, voltage level of the video signal must be high. Because voltage level of the output video signal from the pre-amplifier 306 is relatively low, the video signal must be amplified by the video output amplifier 310 before various picture images can be projected onto the screen 304.

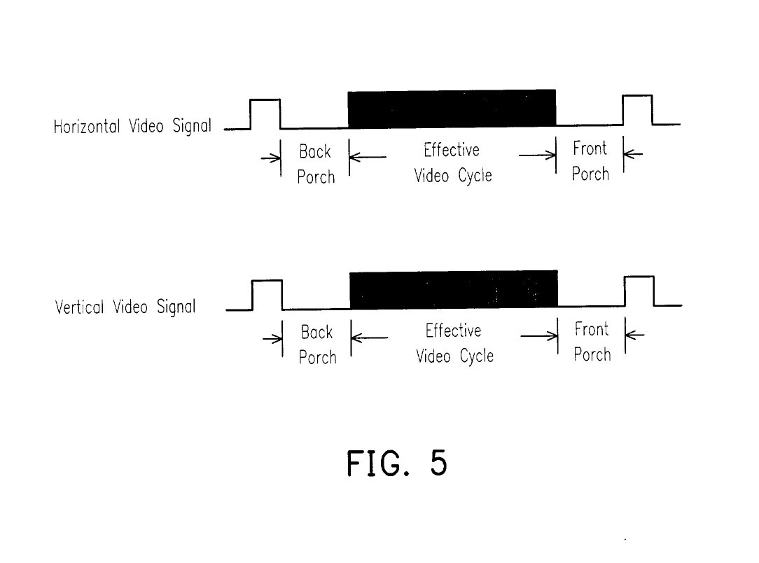

The micro-controller 312 includes a ROM 324, a RAM 326 and an I/O 328. The micro-controller 312 provides a programmable horizontal video signal and a vertical video signal. FIG. 5 is a diagram showing programmable horizontal and vertical video signals generated by a micro-controller. As shown in FIG. 5, the horizontal video signal and the vertical video signal each includes a front porch, an effective video cycle and a back porch respectively. In this embodiment, the micro-controller 312 controls the effective video cycle of the horizontal video signal and the effective video cycle of the vertical video signal to 65% and 85%, respectively. Furthermore, video signal at the front porch and the back porch can be reduced to zero.

The micro-controller 312 transmits the programmable horizontal video signal and vertical video signal to a deflection controller 314. The deflection controller 314 adjusts a picture image to a suitable horizontal size and a suitable vertical size. Thereafter, the horizontal size value and the vertical size value are stored in an EEPROM 316. The micro-controller 312 adjusted the raster scan region such that the raster scan region is in the middle of the screen 304. Vertical position value Vpos of the raster scan region is stored in the EEPROM 316. The vertical position value Vpos is adjusted according to 00-FF (a hexadecimal code) and the shift value thus obtained is stored in the EEPROM 316.

According to the programmable horizontal video signal and the vertical video signal, the micro-controller 312 reads the horizontal size value, the vertical size value, the vertical position value Vpos and the shift value from the EEPROM 316. The micro-controller 312 performs a computation to find relevant data including a horizontal position value, a ratio, a horizontal scan line, a shift vertical position value, a plug-in horizontal size value and a plug-in vertical size value. Such data are used to adjust the picture image.

The deflection controller 314 includes a deflection processor 318 and a deflection/ultra-high voltage circuit 320. The deflection processor 318 is coupled to the micro-controller 312 via a digital bus 322. According to incoming digital data including the horizontal video signal and the vertical video signal (including a horizontal signal having an effective cycle of 65%, a vertical signal having an effective video cycle of 65%, a horizontal signal having an effective video cycle of 85%, a vertical signal having an effective video cycle of 85%, a horizontal front porch, a horizontal back porch, a vertical front porch, a vertical back porch, a horizontal size value, a vertical size value, a horizontal scan line value, a vertical position value Vpos, a shift value, a horizontal position value Hpos, a ratio, a shift vertical position value, a plug-in horizontal size value and a plug-in vertical size value), the deflection processor 318 produces corresponding deflection electrical signals to the deflection/ultra-high voltage circuit 320.

The deflection/ultra-high voltage circuit 320 is coupled to the deflection processor 318. The deflection/ultra-high voltage circuit 320 receives deflection electrical signals from the deflection processor 310 and converts the signals into ultra-high voltage deflection electrical signals. The ultra-high voltage deflection electrical signal is transmitted to the monitor 302 for producing movement and size adjustment of the picture image on the screen 304. The deflection/ultra-high voltage circuit 320 sends out a horizontal flyback signal and a vertical flyback signal to a video detection circuit 308 according to the result of shifting and deflection. Ultimately, the video detection circuit 308 is able to monitor the exact status of image adjustments.

The video detection circuit 308 is a component of an on-screen display (OSD) unit 330. To carry out an adjustment of a picture image, the on-screen display 330 issues a video signal communication frame. The communication frame for adjusting picture image will also appear on the screen 301.

The video detection circuit 308 is coupled to the micro-controller 312 via a digital bus 322. The video detection circuit 308 is capable of receiving the horizontal flyback signal and the vertical flyback signal from the deflection controller 314 and converting the signals into a horizontal flyback digital signal and a vertical flyback digital signal, respectively. The converted horizontal flyback digital signal and vertical flyback digital signal are sent to the micro-controller 312. In addition, the video detection circuit 308 is also capable of receiving video pre-amplified signal (including a horizontal video signal and a vertical video signal) from the video pre-amplifier 306 and converting the signal into digital data. The digital data is transferred to the micro-controller 312 via the digital bus 322.

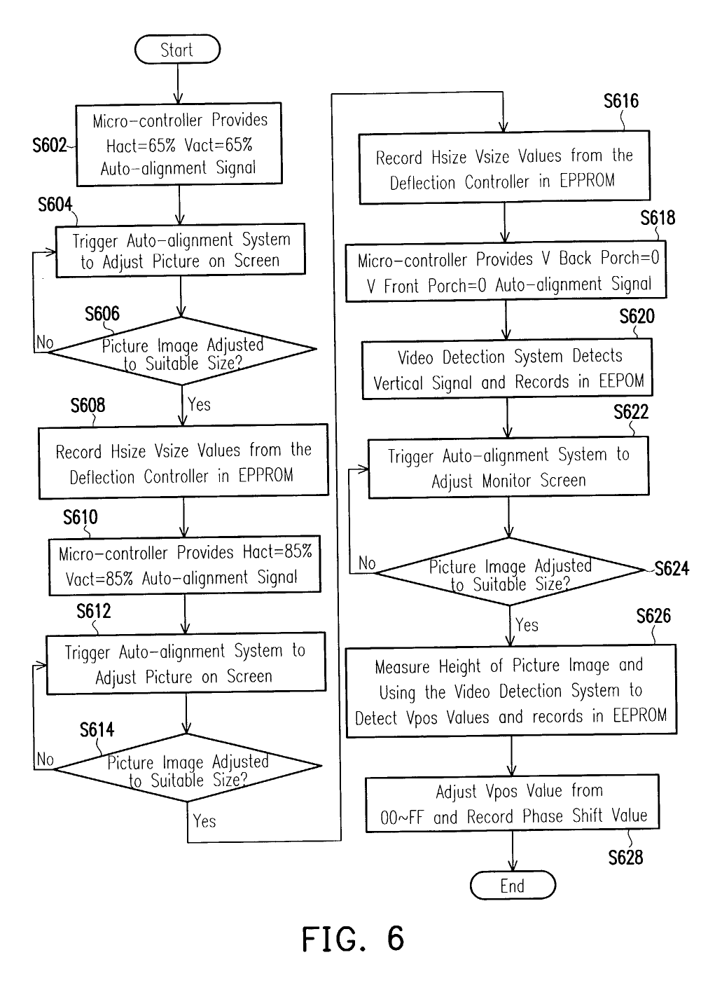

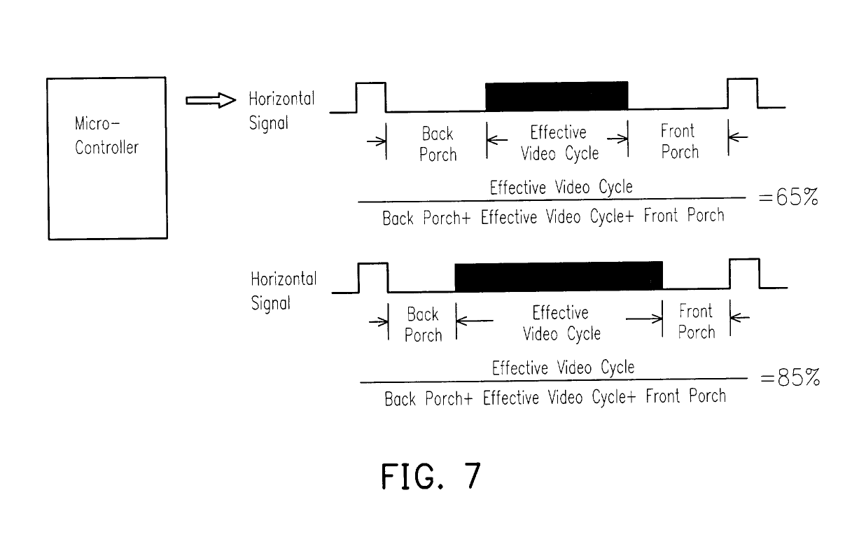

FIG. 6 is a flow chart showing the steps for aligning monitors before delivery to customers according to this invention. As shown in FIG. 6 (also refer to FIG. 3), the steps required to adjust the position and size of a picture image relative to the screen 304 on the monitor 302 before shipping the monitor to a customer is outlined. First, the micro-controller 312 provides a horizontal signal having an effective video cycle of 65% and a vertical signal having an effective video cycle of 65% to the deflection controller 314 (S602). FIG. 7 is a diagram showing a micro-controller providing a horizontal effective video cycle of 65% and 85%, respectively. As shown in FIG. 7, a horizontal signal having an effective video cycle of 65% is given by the following formula,

$$Horizontal signal : \frac{effective\_video \_cycle}{front\_porch + effective\_video \_cycle + back\_porch} = 65 \%$$

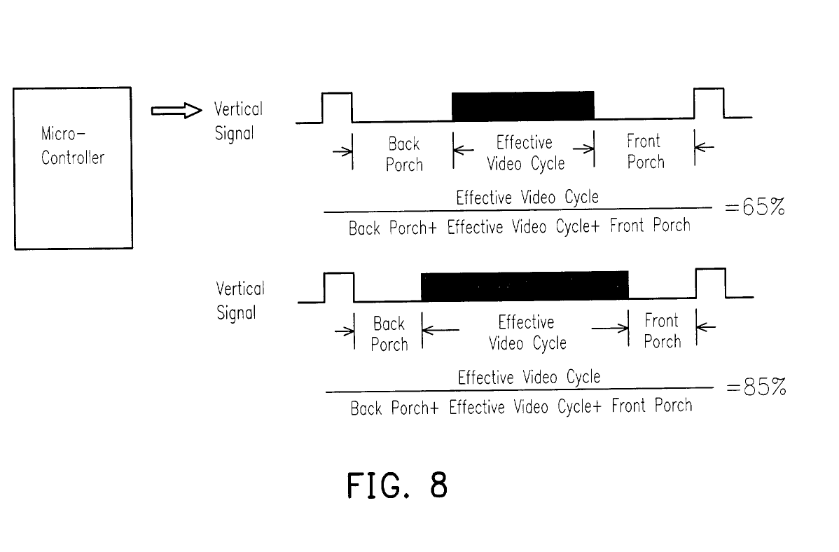

Similarly, FIG. 8 is a diagram showing a micro-controller providing a vertical effective video cycle of 65% and 85%, respectively. As shown in FIG. 8, a vertical signal having an effective video cycle of 65% is given by the following formula,

$$Vertical signal : \frac{effective\_video \_cycle}{front\_porch + effective\_video \_cycle + back\_porch} = 65 \%$$

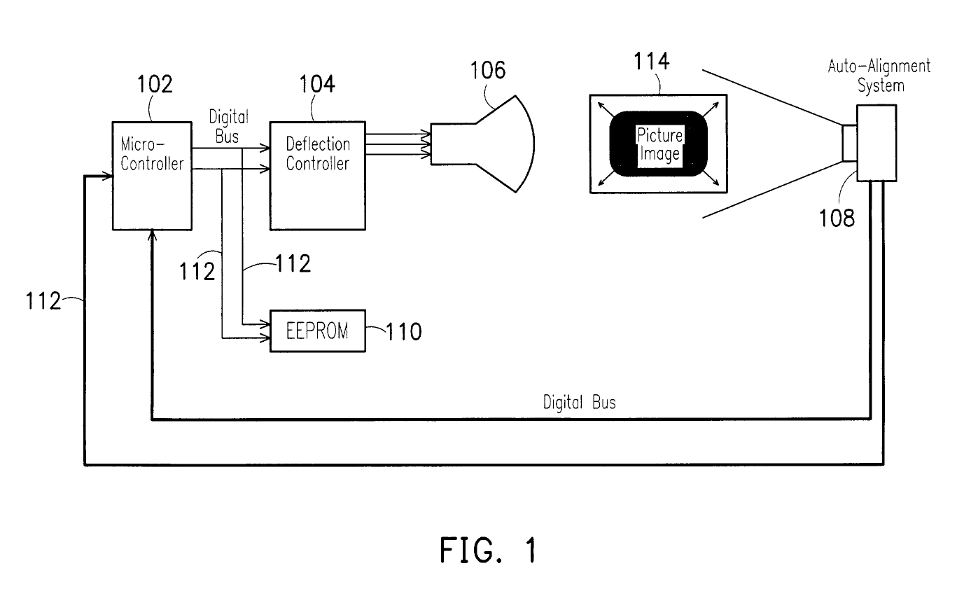

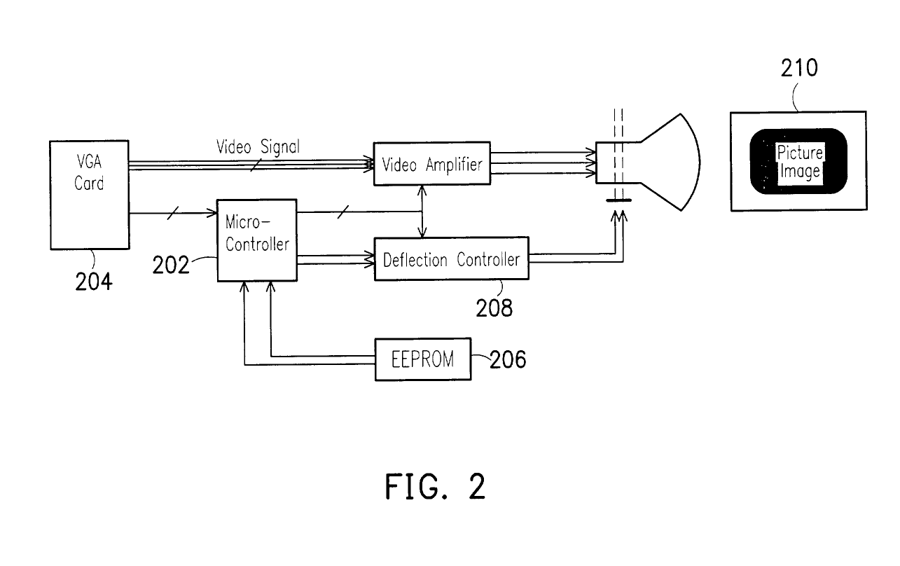

According to the horizontal signal with a 65% effective video cycle and the vertical signal with a 65% effective video cycle, the deflection controller 314 adjusts the picture image to a suitable size. Thereafter, the auto-alignment system 108 (not shown in FIG. 3, refer to FIG. 1) is triggered. Ultimately, the auto-alignment system 108 transfers size and position data of the picture image to the micro-controller 312 (S604) via the digital bus 322.

The micro-controller 312 decides if the picture image is adjusted to a suitable size (S606) or not. If the picture image has not yet reached a suitable size, the micro-controller 312 continues with picture image adjustment in step S604. On the other hand, if the picture image has already reached a suitable size, the horizontal size value Hsize (corresponding to a horizontal signal having an effective video cycle of 65%) and the vertical size value Vsize (corresponding to a vertical signal having an effective video cycle of 65%) detected by the video signal detection circuit 308 from the deflection controller 314 are transmitted to the micro-controller 312. The horizontal size value Hsize and the vertical size value Vsize are transferred from the micro-controller 312 to an EEPROM 316 via the digital bus 322 for storage (S608).

The micro-controller 312 next provides a horizontal signal having an effective video cycle of 85% and a vertical signal having an effective video cycle of 85% to the deflection controller 314 (S610). As shown in FIG. 7, a horizontal signal having an effective video cycle of 85% is given by the following formula,

$$Horizontal signal : \frac{effective\_video \_cycle}{front\_porch + effective\_video \_cycle + back\_porch} = 85 \%$$

Similarly, as shown in FIG. 8, a vertical signal having an effective video cycle of 85% is given by the following formula,

$$Vertical signal : \frac{effective\_video \_cycle}{front\_porch + effective\_video \_cycle + back\_porch} = 85 \%$$

According to the horizontal signal with an 85% effective video cycle and the vertical signal with an 85% effective video cycle, the deflection controller 314 adjusts the picture image to a suitable size. Thereafter, the auto-alignment system 108 (shown in FIG. 1) is triggered. Ultimately, the auto-alignment system 108 transfers size and position data of the picture image to the micro-controller 312 (S612) via the digital bus 322.

The micro-controller 312 decides if the picture image is adjusted to a suitable size (S614) or not. If the picture image has not yet reached a suitable size level, the micro-controller 312 continues with picture image adjustment in step S612. On the other hand, if the picture image has already reached a suitable size level, the horizontal size value Hsize (corresponding to a horizontal signal having an effective video cycle of 85%) and the vertical size value Vsize (corresponding to a vertical signal having an effective video cycle of 85%) detected by the video signal detection circuit 308 from the deflection controller 314 are transmitted to the micro-controller 312. The horizontal size value Hsize and the vertical size value Vsize are transferred from the micro-controller 312 to an EEPROM 316 via the digital bus 322 for storage (S616).

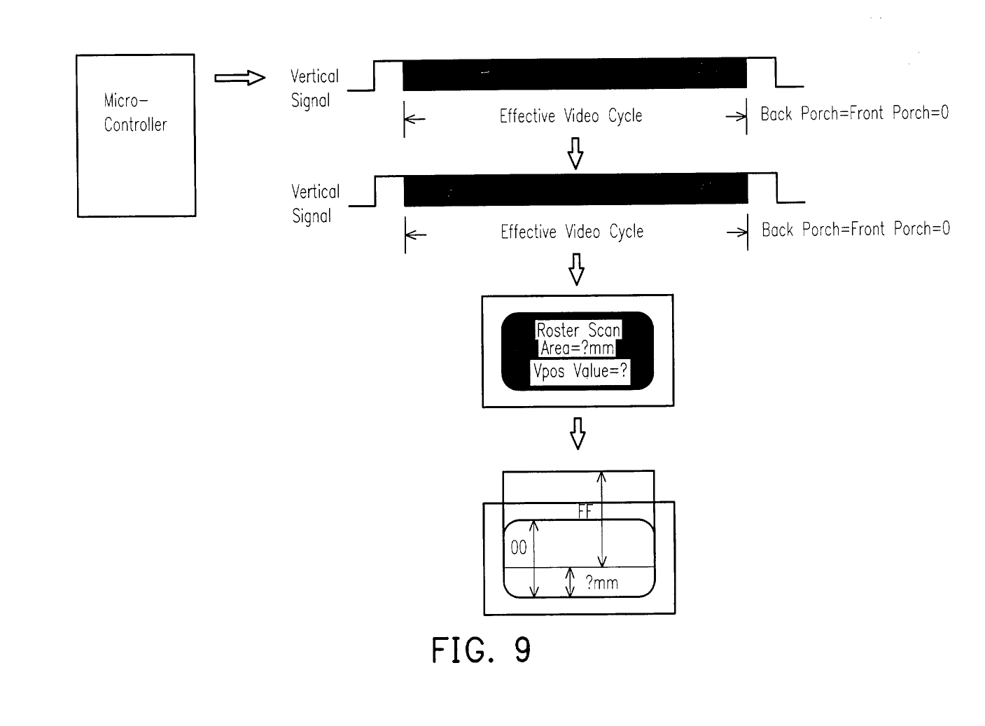

In addition, the micro-controller 312 also provides a vertical signal with front porch=back porch=0. FIG. 9 is a diagram showing a micro-controller providing an auto-alignment signal having a vertical phase. The vertical signal serves as an auto-alignment signal (S618). The video detection circuit 308 detects the number of horizontal scan lines (H lines) occupied by the vertical signal (that is, back porch+video effective cycle+front porch). The value of the number of horizontal scan lines (H lines) is transferred to the EEPROM 316 (S620) for storage. According to the video signals from the micro-controller 312, the deflection controller 314 adjusts the picture image to a suitable size level and triggers the auto-alignment system 108 (shown in FIG. 1). The auto-alignment system 108 transfers position and size data of the picture image to the micro-controller 312 (S622) via the digital bus 322.

The micro-controller 312 decides if the picture image is adjusted to a suitable size (S624) or not. If the picture image has not yet reached a suitable size level, the micro-controller 312 continues with picture image adjustment in step S622. On the other hand, if the picture image has already reached a suitable size level, the deflection controller 314 moves the raster scan region into the middle of the screen 304. The video detection circuit 308 is able to find height of the raster scan (that is, the number of horizontal scan lines (H lines) occupied by the raster scan region) and vertical position value Vpos from the deflection controller 314. The micro-controller 312 transfers the raster scan height value and vertical position value Vpos to the EEPROM 316 (S626) for storage.

The micro-controller 312 adjusts the vertical position value Vpos of the deflection controller 314 according to a hexadecimal code 00-FF (that is, the smallest value—the largest value). The video detection circuit 308 detects the amount of shifting of the video signal relative to the screen 304. Hence, difference in distance between neighboring horizontal scan lines is obtained. Ultimately, the amount of vertical position value Vpos of the deflection controller 314 that needs to be changed to move a unit distance is known. The shift value detected by the video detection circuit 308 is transferred by the micro-controller 312 to the EEPROM 316 (S628) for storage.

Using the case in FIG. 9 as an example and assuming the number of horizontal scan lines occupied by the video effective cycle is 512 H lines and the raster scan height on the screen 304 is 280 mm, when the vertical position value Vpos of the raster scan region is adjusted according to 00-FF, the raster scan region moves a total distance of 70 mm. In other words, distance between neighboring horizontal scan lines is (280/512) mm and 1 mm=(256/70) Vpos. Consequently, for the raster scan region to move a horizontal scan line distance, the vertical position value of the deflection controller 314 must be adjusted to (280/512)*(256/70)=2 Vpos.

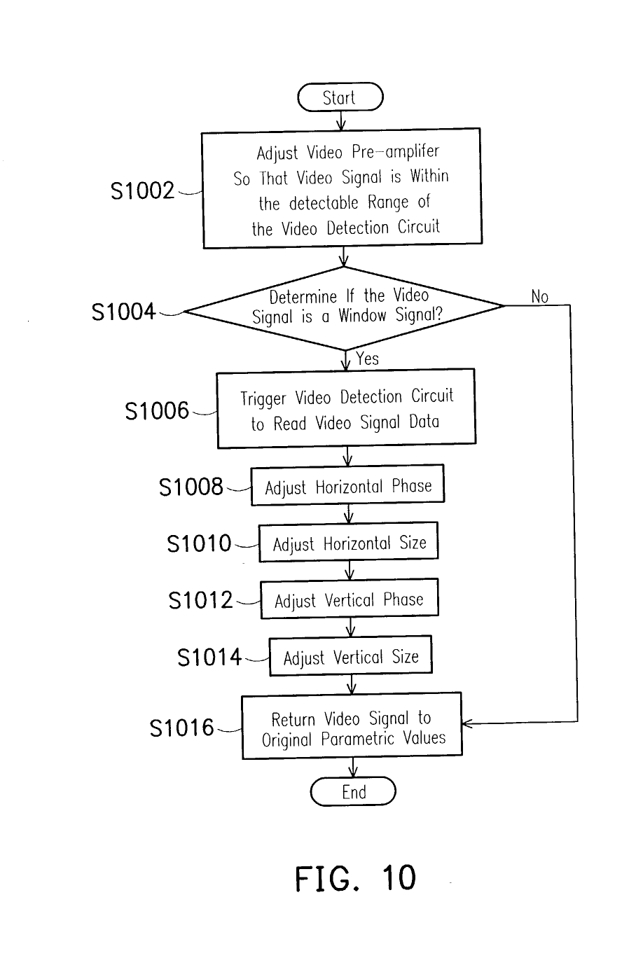

FIG. 10 is a flow chart showing the steps for performing a user-initiated monitor auto-alignment. As shown in FIG. 10 (also refer to FIG. 3), a user initiates the adjustment of position and size of a picture image relative to the screen 304 on the monitor 302 by pressing a button for adjusting picture image. First, video signals (in general 0.7 Vp-p according to FIG. 4) issued from the VGA card 332 are amplified by the video pre-amplifier 306 (in general 4-4.5 Vp-p according to FIG. 4). Therefore, the voltage is raised to a suitable level for use by the video detection circuit 308 (S1002).

The micro-controller 312 decides whether the amplified video signals are window signals or not (S1004). If the video signals are window signals, the micro-controller 312 triggers the video detection circuit 308. The video detection circuit 308 extracts data embedded with the video signals. Data embedded within the video signals include the front and back porch of the horizontal signal, the effective video cycle of the horizontal signal, the front and back porch of the vertical signal, the effective video cycle of the vertical signal. The micro-controller reads off all the data within the video signals as detected by the video detection circuit 308 (S1006).

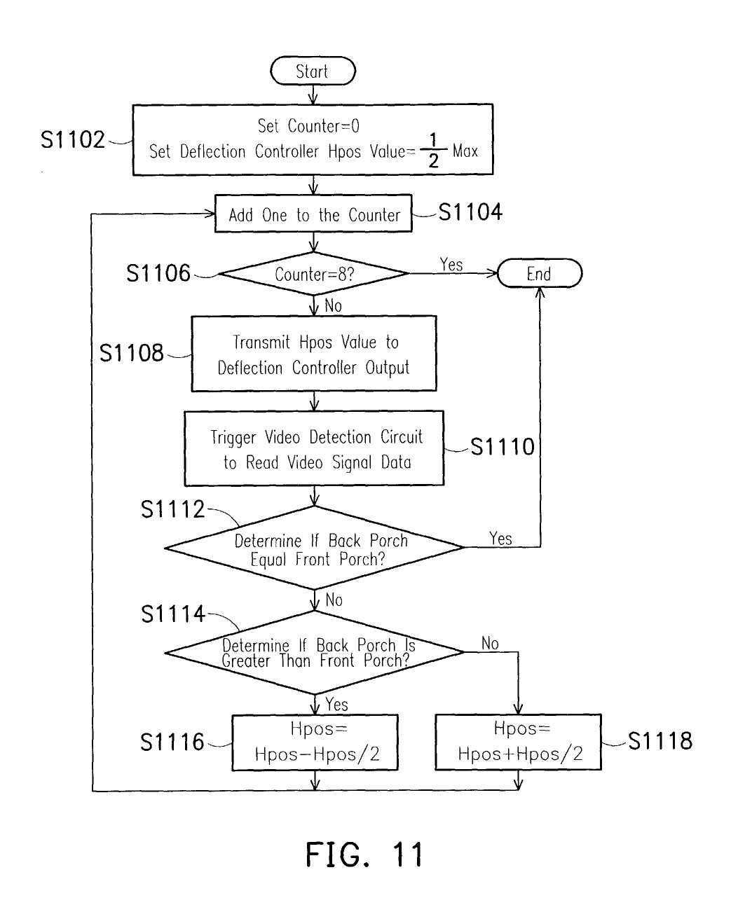

According to the data, the micro-controller 312 controls the deflection controller 314 so that horizontal phase of a picture image can be adjusted (S1008). FIG. 11 is a flow chart showing the steps for performing a horizontal phase adjustment of a picture image. First, the value of a counter (not shown) is set to zero. Using a binary partition method, a horizontal position value Hpos equal to half the largest value (that is, a mid value of 00-FF) is provided by the micro-controller 312 to the deflection controller 314 (S1102).

A value of one is added to the counter (not shown) (S1104) and the count value is compared with a preset value (a preset value of 8 is chosen in this embodiment) (S1106). If the count value equals the preset value, horizontal phase adjustment of the picture image is finished. However, if the count is still smaller than the preset value, the deflection controller 314 issues signals to display picture image according to the horizontal position value Hpos provided by the micro-controller 312 (S1108). The micro-controller 312 reads off the front porch and the back porch of the horizontal signal as detected by the video detection circuit 308 (S1110).

In addition, the micro-controller 112 also decides whether the front porch and the back porch of the horizontal signal are equal or not (S1112). If the front porch and the back porch of the horizontal signal are found to be equal by the micro-controller 112, horizontal phase adjustment of the picture image is complete. On the other hand, if the front porch and the back porch of the horizontal signal are not equal, the micro-controller 312 again checks whether the back porch is greater than the front porch (S1114) or not. If the back porch is still greater than the front porch, the micro-controller 312 computes the horizontal position value Hpos such that Hpos=Hpos−Hpos/2 (S1116) and proceeds back to step S1104. Conversely, if back porch is found by the micro-controller 312 to be less than the front porch, the micro-controller 312 computes the horizontal position value Hpos such that Hpos=Hpos+Hpos/2 (S1116) and proceeds back to step S104.

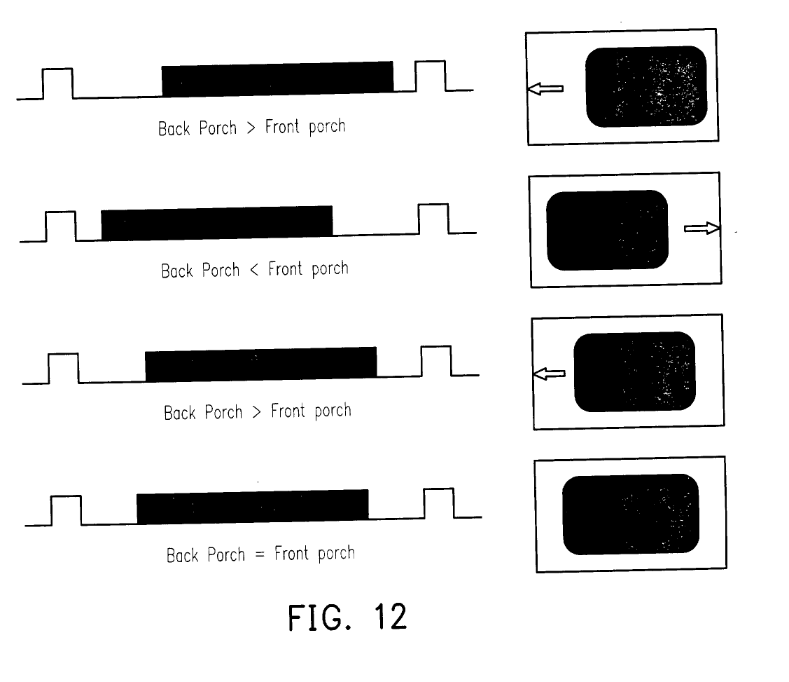

FIG. 12 is a sketch showing various horizontal phase adjustments of a picture image. If the back porch is greater than the front porch, this indicates that the picture image is biased towards the right side of the screen 304. Hence, the horizontal position value Hpos of the deflection controller 314 needs to be adjusted accordingly. That is, Hpos=(1/2 the largest value)−(1/4 of the largest value). Similarly, if the back porch is less than the front porch, this indicates that the picture image is biased towards the left side of the screen 304. Hence, the horizontal position value Hpos of the deflection controller 314 needs to be adjusted accordingly. That is, Hpos=(½ the largest value)−(¼ of the largest value)+(⅛ the largest value). The aforementioned process is repeated until the front and back porch are equal in value. In a worst case scenario, the process is completed within seven repetitions.

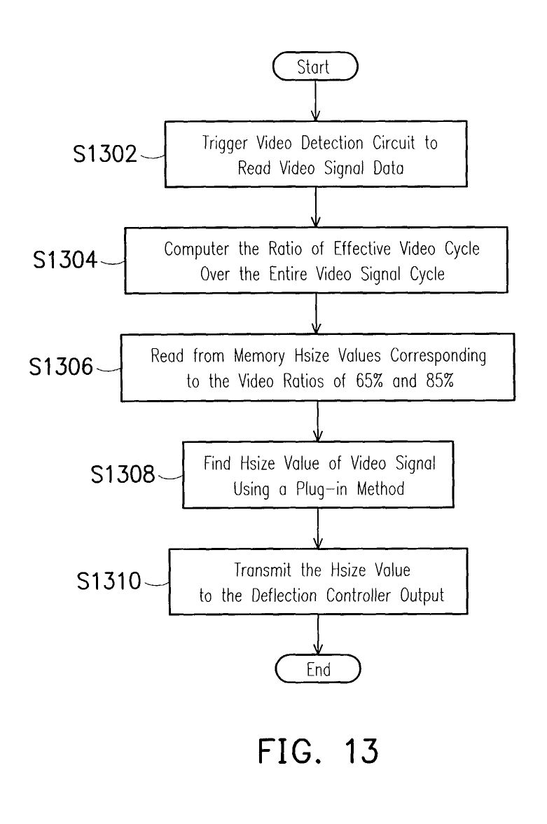

According to video signal data, the micro-controller 312 controls the deflection controller 314 so that horizontal size of the picture image is adjusted (step S1010 in FIG. 10). FIG. 13 is a flow chart showing the steps for performing a horizontal size adjustment of a picture image. First, the micro-controller 312 triggers the video detection circuit 308. The video detection circuit 308 extracts embedded data from the horizontal video signal. The embedded data within the horizontal video signal includes the front porch, the back porch and the effective video cycle. The micro-controller 312 reads the embedded data within the horizontal video signal (S1302) and computes a ratio of the occupation of the effective video signal over the entire horizontal video signal cycle (S1304).

The micro-controller 312 reads out the horizontal size value Hsize corresponding to a video effective cycle of 65% and the horizontal size value Hsize corresponding to a video effective cycle of 85% (S1306). According to the horizontal size value Hsize corresponding to a video effective cycle of 65% and the horizontal size value Hsize corresponding to a video effective cycle of 85%, the micro-controller 312 is able to find a horizontal size value Hsize that corresponds to the effective video signal with the given video effective cycles percentage (S1308) by a plug-in method.

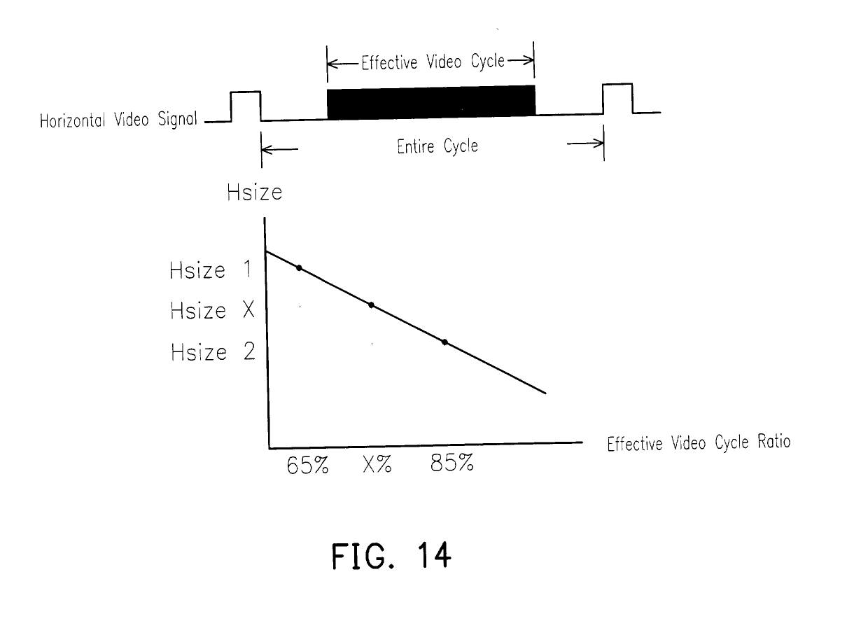

FIG. 14 is a diagram showing the finding of a horizontal size value from a picture image through internal difference. Assume the horizontal size value corresponding to an effective video cycle of 65% is Hsize 1, the horizontal size value corresponding to an effective video cycle of 85% is Hsize 2 and the percentage occupation of the effective video cycle over the entire horizontal video cycle is x%. An internal difference method using the

formula

$$\frac{85 \% - 65 \%}{x \% - 65 \%} = \frac{Hsize\_ 2 - Hsize\_ 1}{Hsize\_x - Hsize\_ 1}$$

can be used to obtain the horizontal size value Hsize X corresponding to an effective video cycle of x%.

The micro-controller 312 sends the computed horizontal size value Hsize to the deflection controller 314. Hence, adjustment of the horizontal size of the picture image is conducted by the deflection controller 314 (S1310).

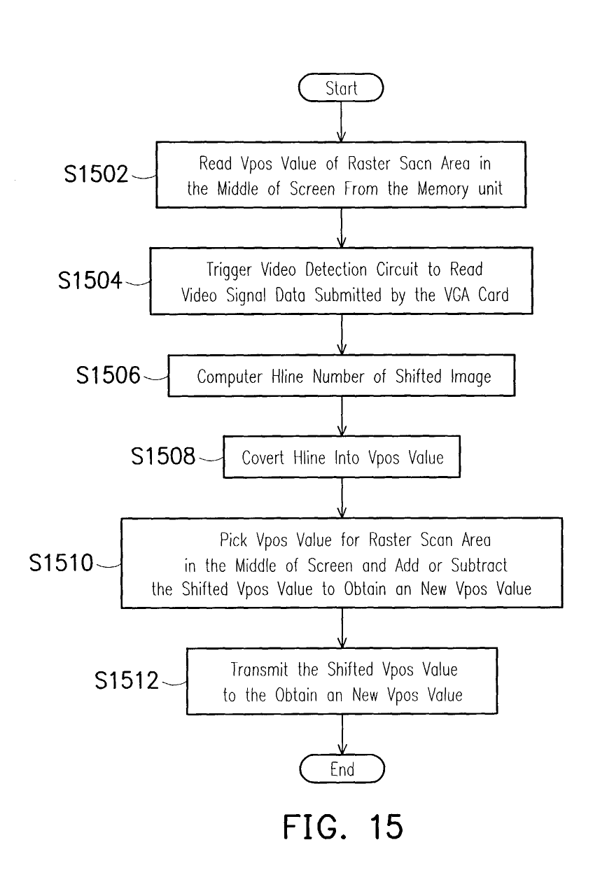

According to input data, the micro-controller 312 controls the deflection controller 314 so that the vertical phase (step S1012 in FIG. 10) of the picture image is adjusted. FIG. 15 is a flow chart showing the steps for performing a vertical phase adjustment of a picture image. First, the micro-controller reads out a vertical position value Vpos from the EEPROM 316. The value serves to place the raster scan region in the middle vertical position value Vpos (S1502). Thereafter, the micro-controller 312 triggers the video detection circuit 308. The video detection circuit 308 checks for any vertical signal issued by the VGA card 332. The micro-controller 312 reads out the front porch and the back porch of the vertical signal from the video detection circuit 308 and determines size of the front porch and the back porch of the vertical signal.

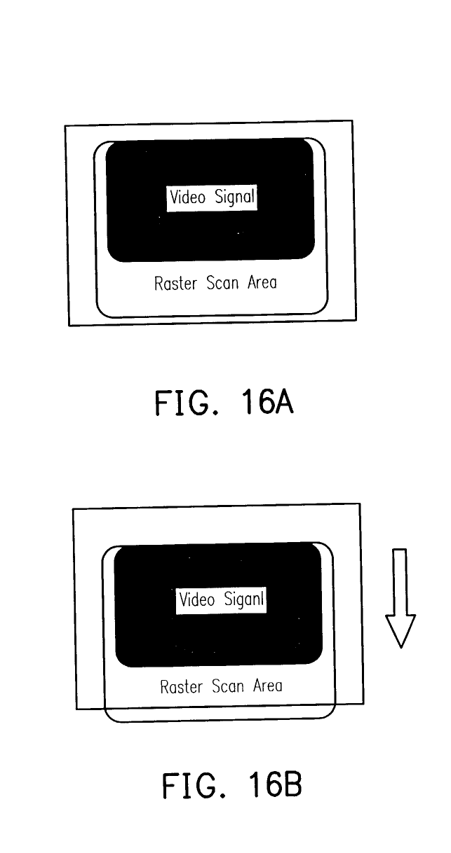

The picture image is not necessarily positioned in the middle of the screen 304. FIG. 16A is a sketch showing a raster scan region displaced from the center of a screen. Hence, the picture image needs to have a vertical phase adjustment. FIG. 16B is a sketch showing the process of moving a raster scan region leading to the positioning of a picture image in the middle of the screen. The micro-controller 312 computes a value according to the formula|back_porch_of_vertical_signal-front_porch_of_vertical_signal|/2. The calculated value is the value for moving the picture image back to the center of the screen 304. The value has a unit in terms of the number of H lines (the number of horizontal scan lines to be adjusted) (S1506).

For example, if the value is 10 H lines, the value is converted into a vertical position value y Vpos (S1508). Moving distance of the picture image relative to the screen 304 is found to be: 10 H lines*280 mm/512 H lines. In other words, the picture image has to move a distance 5.47 mm relative to the screen 304. Since the vertical position value of the vertical signal has altogether 256 steps (hexadecimal code 00-FF), y Vpos=5.47 mm/70 mm*256 steps=20 steps (the figure is rounded up to the nearest integer).

The micro-controller 312 performs an addition or subtraction of the vertical position value Vpos of the raster scan region and the vertical position value y Vpos of the picture image movement (when the back porch is greater than the front porch, a subtraction is conducted, conversely an addition is conducted) so that a new vertical position value Vpos is obtained (S1510). The micro-controller 312 transmits the new vertical position value Vpos to the deflection controller 314. According to the new vertical position value Vpos, the deflection controller 314 moves the picture image into the middle of the screen 304 (S1512).

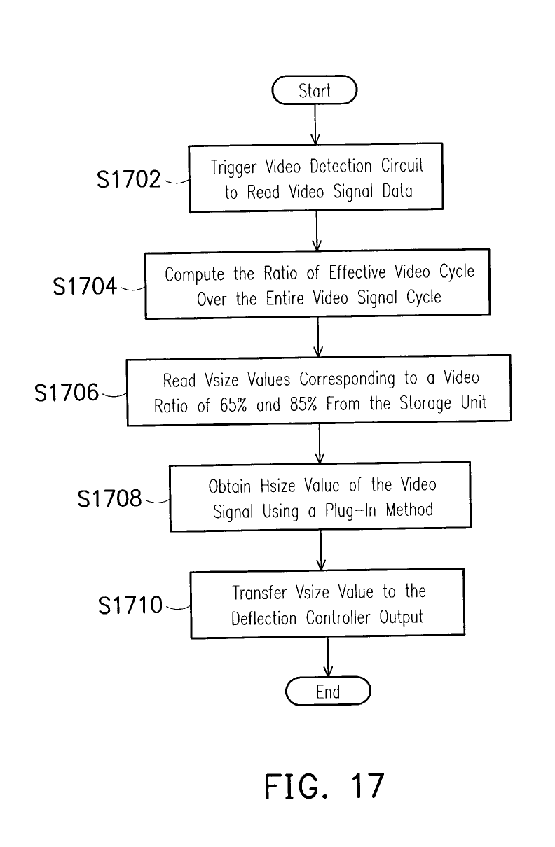

The micro-controller controls the deflection controller 314 according to video data and adjusts the vertical size of the picture image (step S1014 in FIG. 10). FIG. 17 is a flow chart showing the steps for performing a vertical size adjustment of a picture image. First, the micro-controller 312 triggers the video detection circuit 308. The video detection circuit 308 detects data embedded within the vertical video signal. The embedded data within the vertical video signal includes the front porch, the back porch and the effective video cycle. The micro-controller 312 reads the embedded data within the vertical video signal (S1702) and computes a ratio of the occupation of the effective video cycle relative to the entire vertical video signal cycle (S1704).

The micro-controller 312 reads out the vertical size value Vsize corresponding to a vertical signal having an effective video cycle of 65% and the vertical size value Vsize corresponding to a vertical signal having an effective video cycle of 85% (S1706). According to the vertical size value Vsize corresponding to a vertical signal having an effective video cycle of 65% and the vertical size value Vsize corresponding to a vertical signal having an effective video cycle of 85%, a vertical size value Vsize corresponding to the effective video cycle of the given percentage is found (S1708).

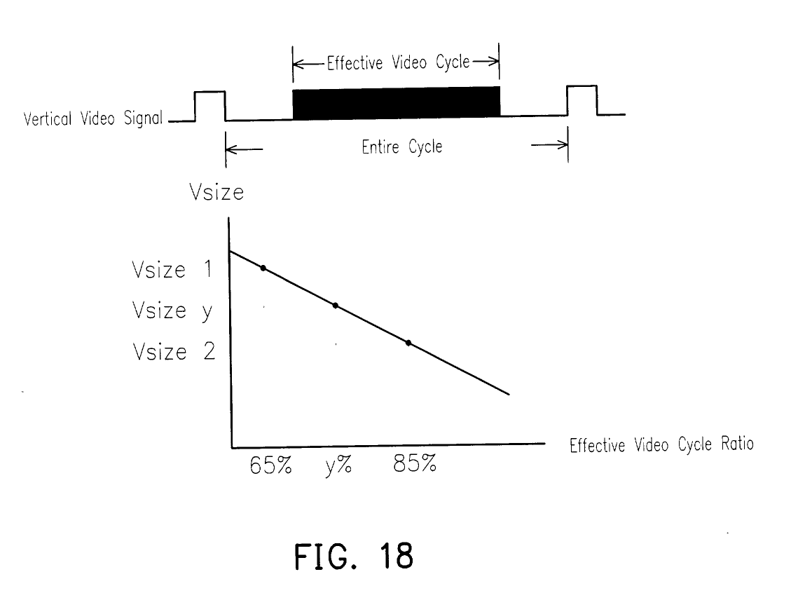

FIG. 18 is a diagram showing the finding of a vertical size value from a picture image through internal difference. Assume the vertical size value corresponding to a vertical signal having an effective video cycle of 65% is Vsize 1, the vertical size value corresponding to a vertical signal having an effective video cycle of 85% is Vsize 2 and the ratio between the effective video cycle over the entire vertical video cycle is y %. Using the internal difference formula:

$$\frac{85 \% - 65 \%}{y \% - 65 \%} = \frac{Vsize2 - Vsize1}{Vsizey - Vsize1} ,$$

a vertical size value V size y corresponding to the effective video cycle of y % is obtained.

The micro-controller 312 transfers the computed vertical size value Vsize to the deflection controller 314 so that the deflection controller 314 can perform a vertical size adjustment of the picture image (S1710).

When the picture image is adjusted to a suitable position and size relative to the screen 304, the micro-controller 312 returns the amplified parameters of the amplified video signal to the original video value (step 1016 in FIG. 10). If the amplified video signal is not a window signal, control is returned to step S1016 in FIG. 10.

In summary, the advantage of this invention includes not having to store horizontal size, horizontal phase, vertical size and vertical phase for a variety of frequency modes. Using the micro-controller to read out video signals, position and size of a picture image relative to a screen is automatically adjusted.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An auto-alignment system for adjusting a position and a size of a picture image relative to a screen on a monitor, the auto-alignment system comprising:
a storage device for holding a horizontal size value, a vertical size value, a vertical position value and a shift value;
a micro-controller for providing a horizontal video signal and a vertical video signal to adjust the size of the picture image and obtain a horizontal size value and a vertical size value of the picture image, wherein the micro-controller stores the horizontal size value and the vertical size value in the storage device and adjusts a raster scan region, the micro-controller also stores a vertical position value of the raster scan region and a shift value in the storage device, and according to the horizontal video signal and the vertical video signal and by reading the horizontal size value, the vertical size value, the vertical position value and the shift value from the storage device, the micro-controller computes a horizontal position value, a ratio value, a horizontal scan line value, a phase shift vertical position value, a plug-in horizontal size value and a plug-in vertical size value of the picture image to serve as data in picture adjustment; and
a deflection controller coupled to the micro-controller for receiving data including the horizontal video signal, the vertical video signal, the horizontal size value, the vertical size value, the horizontal scan line value, the vertical position value, the shift value, the horizontal position value, the ratio value, the horizontal scan line value, the phase shift vertical position value, the plug-in horizontal size value and the plug-in vertical size value, and sending out a deflection signal to the monitor for adjusting the picture image as well as a horizontal flyback signal and a vertical flyback signal; and
a video detection circuit coupled to the micro-controller for receiving the horizontal flyback signal and the vertical flyback signal, converting the signals into a horizontal flyback digital signal and a vertical flyback digital signal and sending the digital signals to the micro-controller, wherein the video detection circuit is also capable of receiving data embedded inside a video pre-amplified signal, converting the signal into digital data and sending the digital data to the micro-controller.

2. The system of claim 1, wherein the auto-alignment system further includes:
a video pre-amplifier for amplifying a video signal into a pre-amplified video signal; and
a video output amplifier coupled to an image pre-amplifier for further amplifying the pre-amplified signal into a larger amplified video signal, wherein the video output amplifier submits an amplified signal to the monitor so that the monitor is able to project a variety of picture types.

3. The system of claim 2, wherein the video pre-amplifier is capable of receiving the video signal submitted by the micro-controller so that an auto-alignment of a picture image relative to the screen of a monitor is conducted before the monitor leaves a factory, and the video pre-amplifier is also capable of receiving the video signal submitted by a VGA card so that the picture image is auto-aligned relative to the screen on the monitor when a user start using the monitor.

4. The system of claim 1, wherein the deflection controller further includes:
a deflection processor coupled to the micro-controller, wherein according to received digital data including the horizontal video signal, the vertical video signal, the horizontal size value, the vertical size value, the horizontal scan line value, the vertical position value, the shift value, the horizontal position value, the ratio value, the phase shift vertical position value, the plug-in horizontal size value and the plug-in vertical size value, the deflection processor converts the received digital data into related deflection electrical signals; and
a deflection/ultra-high voltage circuit coupled to the deflection processor for receiving the deflection electrical signals, converting the signals into ultra-high voltage deflection electrical signals, and sending the ultra-high voltage deflection electrical signals to the monitor, wherein the deflection/ultra-high voltage circuit transfers a result of the deflection shifting as a horizontal flyback signal and a vertical flyback signal to the video detection circuit.

5. The system of claim 1, wherein the video detection circuit further includes a screen display unit that emits a communication frame when conducting picture image adjustment.

6. The system of claim 1, wherein the storage device includes an electrically erasable programmable read only memory.

7. An auto-alignment method for adjusting a position and a size of a picture image relative to a screen on a monitor before the monitor leaves a factory, the method comprising:
providing a horizontal signal having a first effective video cycle ratio and a vertical signal having a first effective video cycle ratio;
according to the first effective video cycle ratio and the vertical signal having a first effective video cycle ratio, suitably adjusting the size of the picture image;
recording a first horizontal size value and a first vertical size value of the picture image;
providing a horizontal signal having a second effective video cycle ratio and a vertical signal having a second effective video cycle ratio;
according to the horizontal signal having a second effective video cycle ratio and the vertical signal having a second effective video cycle ratio, suitably adjusting the size of the picture image;
recording a second horizontal size value and a second vertical size value of the picture image;
providing a signal having a vertical front porch and a vertical back porch both at zero;
recording a horizontal scan line value, wherein the horizontal scan line value is the sum of the vertical front porch, the vertical back porch and the horizontal scan line of an effective video cycle;
adjusting the picture image to a suitable size;
measuring a height of a raster scan region and recording a vertical position value corresponding to the height; and
adjusting the vertical position value according to a vertical adjustment range and recording a shift value according to a relationship between the vertical position value and the horizontal scan line value.

8. The method of claim 7, wherein before recording the first horizontal size value and the first vertical size value of the picture image, whether the picture image has been adjusted to a suitable size is determined, and if not, the size of the picture image is again adjusted.

9. The method of claim 7, wherein before recording the second horizontal size value and the second vertical size value of the picture image, whether the picture image has been adjusted to a suitable size is determined, and if not, the size of the picture image is again adjusted.

10. The method of claim 7, wherein before measuring the height of picture image and recording a corresponding vertical position value, whether the picture image has been adjusted to a suitable size is determined, and if not, the size of the picture image is again adjusted.

11. An auto-alignment method for adjusting a position and a size of a picture image relative to a screen on a monitor, the auto-alignment method comprising:
reading a plurality of data embedded within an amplified video signal;
adjusting a horizontal phase of the picture image according to the data;
adjusting a horizontal size of the picture image according to the data;
adjusting a vertical phase of the picture image according to the data; and
adjusting a vertical size of the picture image according to the data.

12. The method of claim 11, wherein reading the embedded data within the amplified video signal further includes:
amplifying a video signal to a detectable signal range;
determining if the amplified video signal is a window signal or not;
reading the embedded data within the amplified video signal if the amplified video signal is a window signal; and
returning to resetting amplified parametric values within the amplified video signal to the original parametric values.

13. The method of claim 12, wherein the embedded data within the amplified video signal includes a horizontal front porch, a horizontal back porch, an effective horizontal video cycle, a vertical front porch, a vertical back porch and an effective vertical video cycle.

14. The method of claim 13, wherein adjusting the horizontal phase of the picture image according to the embedded data further includes:
setting a counter to zero and setting a horizontal position value of the picture image to a middle value of a vertical adjustment range;
adding one to a counter value;
determining if the counter reaches a preset value;
terminating the horizontal phase adjustment of the image picture if the counter has reached the preset value;
displaying the picture image according to the horizontal position value if the counter has not reached the preset value;
reading the horizontal front porch and the horizontal back porch;
determining whether the horizontal front porch and the horizontal back porch are equal or not;
terminating the horizontal phase adjustment of the picture image if the horizontal front porch is equal to the horizontal back porch;
determining whether the horizontal back porch is greater than the horizontal front porch or not;
subtracting a modified value from the horizontal position value and returning to adding one to the counter value if the horizontal back porch is greater than the horizontal front porch; and
adding the modified value to the horizontal position value and returning to adding one to the counter value if the horizontal back porch is less than the horizontal front porch.

15. The method of claim 13, wherein adjusting the horizontal size of the picture image according to the data further includes:
reading the amplified video signal;
calculating to find a ratio of the effective horizontal video signal over the entire amplified video signal;
reading a first horizontal size value corresponding to a horizontal signal having a first effective video cycle ratio and a second horizontal size value corresponding to a horizontal signal having a second effective video cycle ratio;
according to the horizontal signal having a first effective video cycle ratio, the horizontal signal having a second effective video cycle ratio, the first horizontal size value and the second horizontal size value, using a plug-in method to obtain a plug-in horizontal size value corresponding to the ratio of the effective horizontal video signal over the entire amplified video signal; and
according to the plug-in horizontal size, adjusting the horizontal size of the picture image.

16. The method of claim 13, wherein the step of adjusting the horizontal size of the picture image according to the data further includes:
reading the effective vertical video cycle;
calculating to find a ratio of the effective vertical video signal over the entire amplified video signal;
reading a first vertical size value corresponding to a vertical signal having a first effective video cycle ratio and a second vertical size value corresponding to a vertical signal having a second effective video cycle ratio;
according to the vertical signal having a first effective video cycle ratio, the vertical signal having a second effective video cycle ratio, the first vertical size value and the second vertical size value, using a plug-in method to obtain a plug-in vertical size value corresponding to the ratio; and
according to the plug-in vertical size, adjusting the vertical size of the picture image.
